(19) United States
(12) Patent Application Publication
(10) Pub. No.: US 2015/0073654 A1
(43) Pub. Date: Mar. 12, 2015

(54) METHOD FOR DETERMINING A ROADWAY IRREGULARITY IN A ROADWAY SECTION ILLUMINATED BY AT LEAST ONE HEADLIGHT OF A VEHICLE AND METHOD FOR CONTROLLING A LIGHT EMISSION OF AT LEAST ONE HEADLIGHT OF A VEHICLE

(71) Applicant: Johannes Foltin, Ditzingen (DE)

(72) Inventor: Johannes Foltin, Ditzingen (DE)

(21) Appl. No.: 14/240,688

(22) PCT Filed: Jul. 3, 2012
(86) PCT No.: PCT/EP2012/062902

§ 371 Date: Jun. 5, 2014

(30) Foreign Application Priority Data
Aug. 23, 2011 (DE) 10 2011 081 354.3

(51) Int. Cl. B60Q 1/08; G01B 11/24; G01N 21/47

(52) U.S. Cl. CPC B60Q 1/085; G01N 21/47; G01B 11/24
USPC 701/36; 356/612

(57) ABSTRACT

A method is provided for determining a roadway irregularity in a roadway section illuminated by at least one headlight of a vehicle. The method has a step of recognizing an instantaneous light distribution of the at least one headlight of the vehicle which is produced in the roadway section. The method also has a step of determining the roadway irregularity based on the instantaneous light distribution and a light distribution characteristic for the at least one headlight.

### FIELD OF THE INVENTION

The present invention relates to a method for determining a roadway irregularity in a roadway section illuminated by at least one headlight of a vehicle, to a method for controlling a light emission of at least one headlight of a vehicle, and to a device which is designed to carry out the steps of such a method, and to a computer program product having program code for carrying out such a method.

### BACKGROUND INFORMATION

Known methods for light range control set vehicle headlights in response to a pitching movement of the vehicle. The pitching movement may result from a loading condition of the vehicle and/or vehicle-dynamics reactions of the vehicle. The pitching movement, which also occurs during acceleration procedures, may also be induced by an uneven road.

German Published Patent Appln. No. 20 32 588 discloses a device for automatically setting vehicle headlights having a linkage for tilting the front headlights about a horizontal axis.

### SUMMARY

Against this background, the present invention provides a method for determining a vehicle irregularity in a roadway section illuminated by at least one headlight of a vehicle, a method for controlling a light emission of at least one headlight of a vehicle, a corresponding device, and a corresponding computer program product.

The present invention is based on the finding that a roadway irregularity may be determined on the basis of the light distribution of the vehicle headlights. The roadway irregularity may be detected anticipatorily in particular. Based on the detected roadway irregularity, for example, a light emission of vehicle headlights may be adapted. The adaptation may take place in such a way that a light range of the vehicle headlights does not change or only changes insignificantly when the vehicle moves over the roadway irregularity.

One advantage of the present invention is that due to an anticipatory detection of a roadway irregularity ahead of a vehicle, a timely adaptation of relevant vehicle systems to the roadway irregularity may be carried out. In addition, the determination of the roadway irregularity may be carried out at least partially with the aid of devices which are routinely provided in a vehicle, for example, a vehicle camera and headlights. Thus, for example, the roadway irregularity may be taken into consideration in the activation of light systems of the vehicle, to avoid or substantially reduce dazzling of other road users. As a result of the knowledge with respect to an upcoming roadway irregularity and, for example, possible precautionary compensation measures thus made possible, traffic safety may be increased. For example, uniformly reliable safe illumination of the road may be made possible even though the vehicle moves over a roadway irregularity.

The present invention provides a method for determining a roadway irregularity in a roadway section illuminated by at least one headlight of a vehicle, the method having the following steps:

recognizing an instantaneous light distribution of the at least one headlight of the vehicle, which is produced in the roadway section; and
determining the roadway irregularity based on the instantaneous light distribution and a light distribution which is characteristic for the at least one headlight.

The vehicle may be a motor vehicle, in particular a road-based motor vehicle, for example, a passenger automobile or a truck. The vehicle may be in movement while the steps of the method are executed. The at least one headlight may be a front headlight of the vehicle, for example. The at least one headlight illuminates a section of the roadway adjacent to the vehicle, for example, in the travel direction ahead of the vehicle. The at least one headlight produces a light distribution on the roadway. The light distribution relates to a distribution of the headlight light on the roadway, in particular a distribution of a light quantity, a distribution of a degree of reflection of the roadway, and the like. The light distribution may be recorded, for example, with the aid of a camera or image processing unit, which is oriented in the forward travel direction of the vehicle, and subsequently recognized using a suitable recognition method. The light distribution may therefore be provided in the form of image data or analyzed image information. The characteristic light distribution may be a typical, predefined, standardized or calibrated light distribution. The characteristic light distribution may be used as a reference light distribution to determine the roadway irregularity. The characteristic light distribution may be predetermined and may be read out of a memory during the execution of the method. The characteristic light distribution may be determined in a situation, for example, in which the vehicle is located on a roadway having a level surface. Upon the presence of a roadway irregularity in the roadway section illuminated by the at least one headlight, the characteristic light distribution may deviate from the instantaneous light distribution. The instantaneous light distribution may be a variant of the characteristic light distribution which is changed by the roadway irregularity. The roadway irregularity may be caused, for example, by a bump, a pothole, ruts, or the like. The instantaneous light distribution may deviate from the characteristic light distribution in the area of the roadway irregularity.

According to one specific embodiment, in the step of determining, a step of combining the recognized, instantaneous light distribution and the characteristic light distribution may be carried out to produce a combined light distribution. The roadway irregularity may be determined based on the combined light distribution. In the step of combining, the light distributions may be combined while forming a difference, superposition, or the like. In the step of combining, methods of arithmetic and/or image processing may be applied. The combined light distribution may represent, for example, a possible deviation of the instantaneous light distribution from the characteristic light distribution. Such a combination offers the advantage that the presence of a roadway irregularity may be determined clearly and reliably from the combined light distribution.

A step of checking whether the combined light distribution meets a roadway irregularity condition may also be provided. In the step of determining, the roadway irregularity may be determined if the combined light distribution meets the roadway irregularity condition. The roadway irregularity condition may be designed, for example, to make the largest possible number of variants of roadway irregularities identifiable. Such a check offers the advantage that a variety of possible roadway irregularities may be identified reliably, efficiently, and with little effort on the basis of the roadway irregularity condition.

In this case, the roadway irregularity condition may have at least one light distribution pattern, which represents a presence and/or a property of a roadway irregularity. The light distribution pattern may correspond to a pattern of a light distribution as may be recognized upon the presence of a roadway irregularity. The light distribution pattern may have, for example, a so-called shading pattern, a pattern of a light quantity distribution, or the like. Therefore, in the step of checking, based on the roadway irregularity condition in the form of the at least one light distribution pattern, a pattern comparison, a pattern recognition, or the like may be carried out. If the at least one light distribution pattern is identified in the combined light distribution, this indicates the presence of a roadway irregularity. In addition, the light distribution pattern may allow conclusions to be drawn about a shape, a size, an angle of inclination, and/or another property of the roadway irregularity. For example, it may be recognized on the basis of such a roadway irregularity condition whether the roadway irregularity represents a crest or a trough in the roadway. Such a roadway irregularity condition offers the advantage that the precision of the determination of a roadway irregularity may be increased.

Furthermore, the present invention provides a method for controlling a light emission of at least one headlight of a vehicle, the method having the following steps:

determining a roadway irregularity according to the method; and
ascertaining an item of control information for controlling the light emission of the at least one headlight of the vehicle based on the roadway irregularity.

The light emission of the at least one headlight may be variable in steps or continuously in this case. The light emission of the headlight may be changed with respect to the emission characteristic of the headlight. The emission characteristic may represent a brightness, a light angle, and/or the like. The control information may have the effect that the light emission or emission characteristic of the at least one headlight is changed in such a way that a light range of the at least one headlight may be maintained. The control information may be output via an interface to the at least one headlight and/or a control unit for activating the at least one headlight.

According to one specific embodiment, the step of ascertaining may be executed before the vehicle reaches the determined roadway irregularity. Such a specific embodiment offers the advantage that on the basis of the anticipatorily ascertained control information, a precautionary adaptation of the light emission may be carried out. A control of the light emission may thus be adapted to reaching the roadway irregularity and carried out in a timely manner. Dazzling of other road users may thus be reduced further and visibility of the course of the road when traveling over roadway irregularities may be improved.

A step of generating a pitching movement value for the at least one headlight based on the determined roadway irregularity may also be provided. In the step of ascertaining, the control information may be designed to control the light emission of the at least one headlight while using the generated pitching movement value. When the vehicle moves over the roadway irregularity, a pitching movement of the vehicle, and therefore also of the at least one headlight, may result. In the step of generating the pitching movement value, a direction and an absolute value of a pitching movement or an absolute value of a pitching angle may be estimated and therefore quantified. The control information may therefore be designed, to activate the at least one headlight upon use, so that such a pitching movement of the at least one headlight may be compensated for or equalized or corrected.

In addition, in the step of ascertaining, the control information may additionally be ascertained based on surroundings data and/or travel data of the vehicle. The surroundings data may have, for example, a topology or topography of the road, which may be received by a navigation device or the like, for example. The surroundings data may therefore indicate, for example, curves, uphill grades or down-grades, and the like. The travel data may have vehicle dynamics information, for example, speed information, acceleration information, road holding information, etc., position information, and/or loading information with respect to the vehicle. A pitching movement of the vehicle, which is to be taken into consideration during the control of the light emission, is also dependent on such vehicle dynamics information. Such a consideration of surroundings data and/or travel data offers the advantage that the precision of the determination of roadway irregularities may be further increased. The utilization of surroundings data and/or travel data may additionally allow a plausibility check of the determined roadway irregularities and therefore increase the reliability of a correct recognition of the roadway irregularities.

Furthermore, the present invention provides a device which is designed to carry out or implement the steps of one of the above-mentioned methods. In particular, the device may have units which are each designed to execute one step of one of the above-mentioned methods. The object on which the present invention is based may also be achieved rapidly and efficiently by these embodiment variants of the present invention in the form of a device.

A device may be understood in the present case as an electrical device or control unit, which processes sensor signals and outputs control signals as a function thereof. The device may have an interface, which may be designed in hardware and/or software. In the case of a hardware-based design, the interfaces may be part of a so-called system ASIC, for example, which contains greatly varying functions of the device. However, it is also possible that the interfaces are independent, integrated circuits or at least partially consist of discrete components. In the case of a software-based design, the interfaces may be software modules, which are provided on a microcontroller in addition to other software modules, for example.

A computer program product having program code is also advantageous, which is stored on a machine-readable medium such as a semiconductor memory, a hard drive memory, or an optical memory and is used to carry out a method according to one of the above-described specific embodiments when the program is executed on a device.

### BACKGROUND INFORMATION

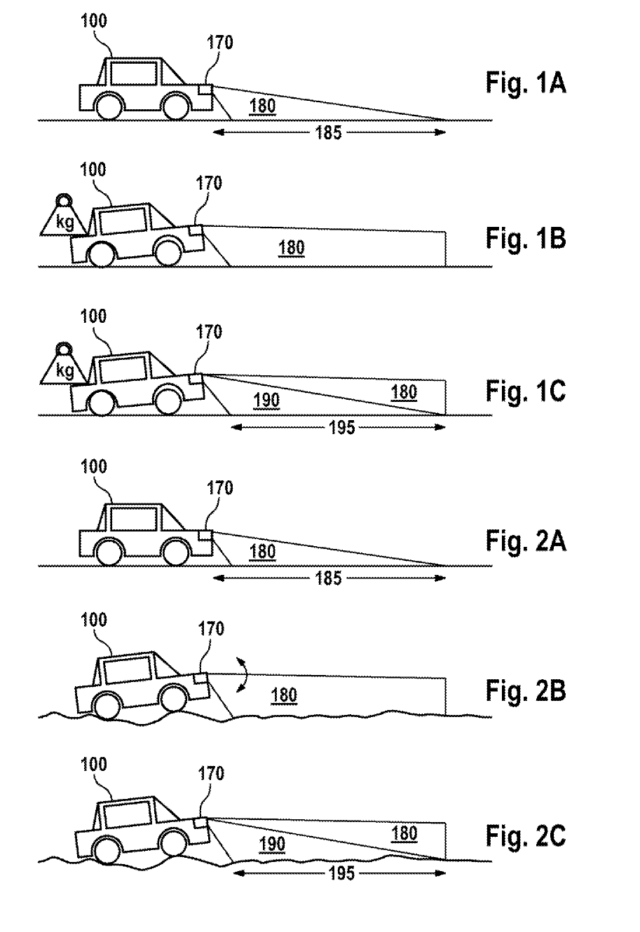

FIGS. 1A through 4B show views of various light cones of a vehicle.

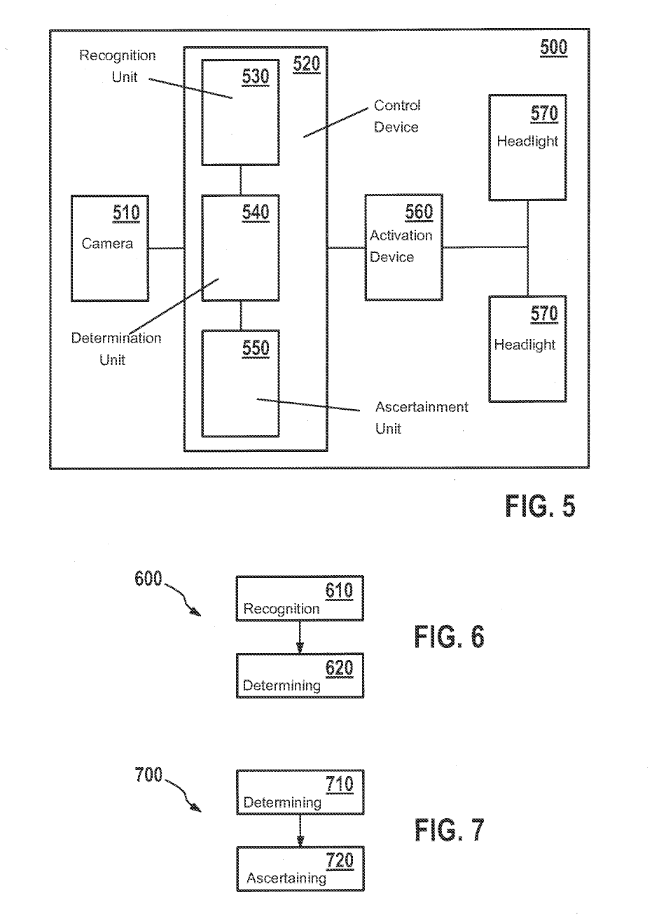

FIG. 5 shows a schematic view of a vehicle having a control device according to one exemplary embodiment of the present invention.

FIG. 6 shows a flow chart of a method according to one exemplary embodiment of the present invention.

FIG. 7 shows a flow chart of a method according to one exemplary embodiment of the present invention.

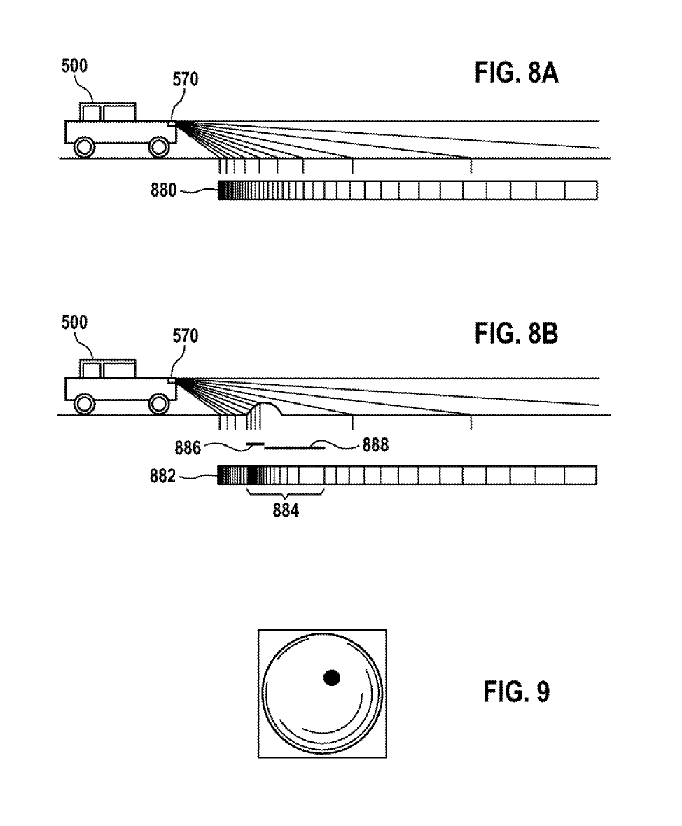

FIGS. 8A and 8B show views of various light distributions of a vehicle.

FIG. 9 shows a view of a two-dimensional image having a three-dimensional effect.

### DETAILED DESCRIPTION

In the following description of preferred exemplary embodiments of the present invention, identical or similar reference numerals are used for the elements which are shown in the various figures and act similarly, a repeated description of these elements being omitted.

FIG. 1A shows a view of a light cone of a vehicle in the case of a uniformly loaded or unloaded condition. A vehicle 100, a headlight 170, a light cone 180, and a light range 185 are shown. Headlight 170 is one of typically two front headlights of vehicle 100. Headlight 170 of vehicle 100 produces light cone 180. Light cone 180 has light range 185 of approximately 65 m.

FIG. 1B shows a view of a light cone of a vehicle in the case of a loaded or unevenly loaded condition. The view in FIG. 1B corresponds to the view from FIG. 1A with the exception that a rear axle of vehicle 100 is more strongly loaded than a front axle of vehicle 100. Vehicle 100 therefore has an angle of inclination or pitch angle in relation to the roadway. Light cone 180 is thus raised further in relation to the roadway than in the view from FIG. 1A and therefore has a greater light range.

FIG. 1C shows a view of a light cone of a vehicle in the case of an unevenly loaded condition while using a static light range control. The view in FIG. 1C corresponds to the view from FIG. 1B with the exception that in addition an adapted light cone 190 and an adapted light range 195 are shown. Adapted light cone 190 has adapted light range 195. Adapted light cone 190 having adapted light range 195 results under application of the static light range control. The classic, static light range control (LRC) adapts a light emission of headlight 170 of vehicle 100 automatically to a loading condition of vehicle 100. A light emission of headlight 170 is changed in such a way that light cone 180 is lowered, so that adapted light cone 190 results. Adapted light range 195 may correspond to the light range from FIG. 1A, i.e., it may be approximately 65 m. A load compensation is carried out by the static light range control with respect to the light emission of headlight 170.

FIG. 2A shows a view of a light cone of the vehicle. The view in FIG. 2A corresponds to the view from FIG. 1A. FIG. 2A shows in this case vehicle 100 on a level roadway or in an unloaded condition.

FIG. 2B shows a view of a light cone of a vehicle on an uneven roadway. The roadway has irregularities in this case. The view in FIG. 2B corresponds to the view from FIG. 2A with the exception that vehicle 100 has an angle of inclination or pitch angle in relation to the roadway as a result of the uneven roadway. A front axle of vehicle 100 is located at a higher level with respect to an average roadway level in this case than a rear axle of vehicle 100. Light cone 180 is therefore raised further with respect to the roadway than in the view from FIG. 2A.

FIG. 2C shows a view of a light cone of a vehicle on an uneven roadway while applying a dynamic light range control. The view in FIG. 2C corresponds to the view from FIG. 2B with the exception that in addition an adapted light cone 190 and an adapted light range 195 are shown. Adapted light cone 190 has adapted light range 195. Adapted light cone 190 having adapted light range 195 results under application of the dynamic light range control. A light emission of headlight 170 is changed in such a way that light cone 180 is lowered, so that adapted light cone 190 results. Adapted light range 195 may correspond to the light range from FIG. 2A, i.e., it may be approximately 65 m. In the case of dynamic light range control, headlight 170 is dynamically adapted to the conditions of the road and the vehicle dynamics. Light cone 180 is thus lowered during acceleration procedures, adapted light cone 190 resulting, so as not to dazzle other road users. In contrast, headlight 170 is raised during braking, to compensate for the reduced range, induced by the pitching movement. The pitching movements, which also occur during acceleration procedures, may also be induced by an uneven road or roadway.

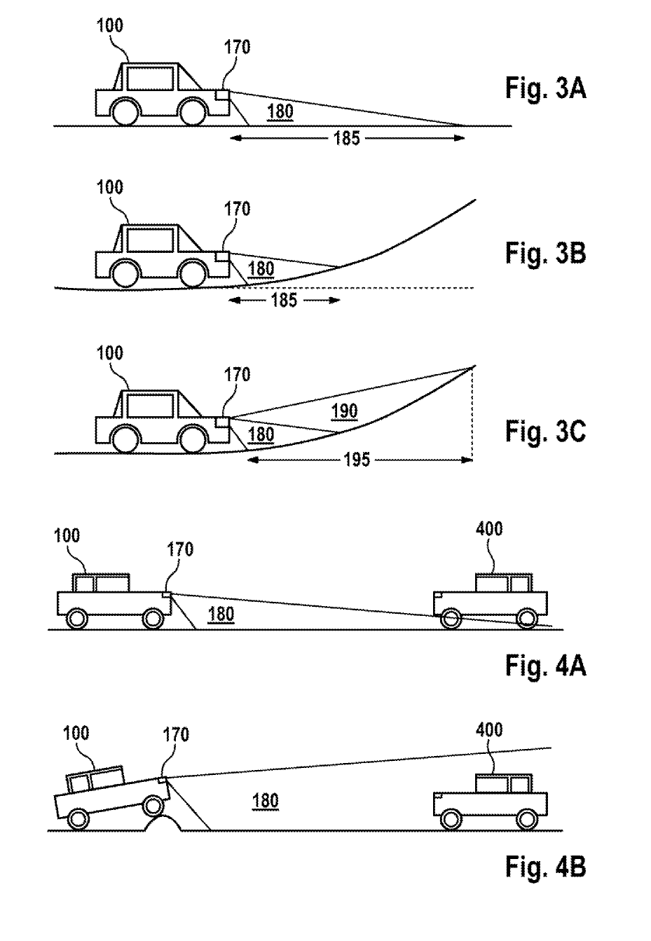

FIG. 3A shows a view of a light cone of a vehicle. The view in FIG. 3A corresponds to the view from FIG. 1A or 2A. FIG. 3A shows in this case vehicle 100 on an even roadway or in an unloaded condition.

FIG. 3B shows a view of a light cone of a vehicle before an uphill grade in the course of the road. The uphill grade in the course of the road causes the roadway to rise ahead of vehicle 100. Light cone 180 is incident on the rising roadway. Therefore, light range 185 is shortened in relation to the light range from FIG. 3A, i.e., it is less than 65 m. The light emission of headlight 170 is not adapted to a topography of the road in this case.

FIG. 3C shows a view of a light cone of a vehicle before an uphill grade in the course of the road having a compensation of the road topography by dynamic light range control. The view in FIG. 3C corresponds to the view from FIG. 2B with the exception that in addition an adapted light cone 190 and an adapted light range 195 are shown. Adapted light cone 190 has adapted light range 195. Adapted light cone 190 having adapted light range 195 results under application of the dynamic light range control to compensate for the road topography. A light emission of headlight 170 is changed in such a way that light cone 180 is raised, so that adapted light cone 190 results. Adapted light range 195 may correspond to the light range from FIG. 2A, i.e., it may be approximately 65 m. The light emission of headlight 170 is therefore adapted to the topography of the roadway.

FIG. 4A shows a view of a light cone of a vehicle on a level roadway. The view in FIG. 4A corresponds to the view from FIG. 1A, FIG. 2A, or FIG. 3A with the exception that in addition another vehicle 400 is shown. The other vehicle 400 is an oncoming vehicle toward vehicle 100. The other vehicle 400 therefore has a travel direction which is opposite to a travel direction of vehicle 100. Light cone 180 of vehicle 100 captures a roadway-proximal section of the other vehicle 400.

FIG. 4B shows a view of a light cone of a vehicle upon the presence of a roadway irregularity. The view in FIG. 4B corresponds to the view from FIG. 4A, with the exception that a front axle of vehicle 100 is located in the area of a roadway irregularity, the front axle of vehicle 100 being raised in relation to a rear axle of vehicle 100. The roadway irregularity is a bump or a projection in the roadway in this case. Light cone 180 is therefore raised further in relation to the roadway than in the view from FIG. 4A. Light cone 180 of vehicle 100 captures the other vehicle 400 in its entire height in this case, for example. Therefore, dazzling of a driver of the other vehicle 400 occurs due to flashing of the headlights, caused by the bump or roadway irregularity.

The above-mentioned concepts for light range control according to FIGS. 1A through 4B are not anticipatory, whereby flashing of headlight 170 of vehicle 100 and therefore dazzling always occurs from the viewpoint of the other vehicle 400, i.e., the oncoming traffic, when vehicle 100 travels over a roadway irregularity or a bump. Such small, rapid changes of the pitch angle of vehicle 100 may only be regulated by the static and/or dynamic light range control in the event of a detected position change of vehicle 100.

FIG. 5 shows a schematic view of a vehicle 500 having a control device according to one exemplary embodiment of the present invention. Vehicle 500 has a vehicle camera 510, a control device 520 having a recognition unit 530, a determination unit 540, and an ascertainment unit 550, an activation device 560, and two headlights 570. Vehicle camera 510 is connected to control device 520 and activation device 560 is connected to control device 520, for example, in each case via at least one signal line. Control device 520 is therefore connected between vehicle camera 510 and control device 560. Headlights 570 are connected to activation device 560 via at least one signal line, for example. Activation device 560 is therefore connected between control device 520 and headlights 570. Although it is not thus shown in FIG. 5, activation device 560 may also be a part of control device 520 or control device 520 may also be a part of activation device 560.

Vehicle camera 510 may have image processing electronics. Vehicle camera 510 is designed to record at least one image of a light distribution produced by headlights 570 on a roadway section which is illuminated by headlights 570 and output this image in the form of image information, image data, or an image signal to control device 520.

Control device 520 has recognition unit 530, determination unit 540, and ascertainment unit 550. Control device 520 is designed to carry out a determination of a roadway irregularity in a roadway section, which is illuminated by at least one headlight 570 of vehicle 500, to carry out a control of a light emission of headlights 570 of vehicle 500. Recognition unit 530, determination unit 540, and ascertainment unit 550 of control device 520 are connected to one another.

Recognition unit 530 is designed to receive the image information, the image data, or the image signal from vehicle camera 510. Recognition unit 530 is designed to recognize, based on the data received from vehicle camera 510, the instantaneous light distribution of headlights 570 of vehicle 500 produced in the roadway section. In particular, recognition unit 530 may recognize the instantaneous light distribution from the image information, the image data, or the image signal from vehicle camera 510. For this purpose, recognition unit 530 may use suitable methods for image processing, image analysis, pattern recognition, object recognition, and/or the like. Recognition unit 530 may output the instantaneous light distribution to determination unit 540.

Determination unit 540 is designed to receive the instantaneous light distribution from recognition unit 530. Determination unit 540 is designed to determine the roadway irregularity based on the instantaneous light distribution and a light distribution characteristic for headlights 570. The light distribution characteristic for headlights 570 may represent a predefined light distribution for an instantaneous setting of the light emission of headlights 570. The characteristic light distribution may be read out from a storage unit, for example, a reference table, in which multiple characteristic light distributions for different instantaneous settings of the light emission may also be stored. The storage unit may be a part of one of the units of control device 520 or may also be situated outside control device 520. Determination unit 540 may carry out a suitable combination of the light distributions to determine the roadway irregularity. Determination unit 540 is designed to output an item of information about the roadway irregularity to ascertainment unit 550.

Ascertainment unit 550 is designed to receive the information about the roadway irregularity from determination unit 540. Ascertainment unit 550 is designed to ascertain an item of control information for controlling the light emission of headlight 570 of vehicle 500 in consideration of the roadway irregularity.

Control device 520 is designed to output the control information, for example, in the form of a control information signal, to activation device 560.

Activation device 560 is designed to receive the control information from control device 520. Activation device 560 is also designed to generate a control signal to activate headlights 570. The activation device may consider or use the control information for controlling the light emission of headlights 570 during the generation of the control signal. The control signal may therefore contain the control information. Activation device 560 is designed to output the control signal to headlights 570.

Headlights 570 may receive the control signal from activation device 560. The control information in the control signal may cause the light emission to be adapted to the roadway irregularity. In particular, an effect of the roadway irregularity on a pitch angle of vehicle 500 or headlights 570 may be compensated for.

FIG. 6 shows a flow chart of a method 600 for determining a roadway irregularity in a roadway section illuminated by at least one headlight of a vehicle, according to one exemplary embodiment of the present invention. The vehicle may be the vehicle from FIG. 5. Method 600 has a step of recognition 610 of an instantaneous light distribution, which is produced in the roadway section, of the at least one headlight of the vehicle. Method 600 also has a step of determining 620 the roadway irregularity based on the instantaneous light distribution and a light distribution characteristic for the at least one headlight. Method 600 may advantageously be executed in conjunction with a device, for example, the control device from FIG. 5.

FIG. 7 shows a flow chart of a method 700 for controlling a light emission of at least one headlight of a vehicle, according to one exemplary embodiment of the present invention. The vehicle may be the vehicle from FIG. 5. Method 700 has a step of determining 710 a roadway irregularity. Step of determining 710 has the steps of the method from FIG. 6. Method 700 also has a step of ascertaining 720 an item of control information for controlling the light emission of the at least one headlight of the vehicle based on the roadway irregularity. Method 700 may advantageously be executed in conjunction with a device, for example, the control device from FIG. 5.

Therefore, the control device from FIG. 5 may be designed to carry out the steps of method 600 from FIG. 6 and/or the steps of method 700 from FIG. 7.

FIG. 8A shows a view of a light distribution of a vehicle on a level roadway or in a uniformly loaded condition. A vehicle 500, a headlight 570, and a light distribution 880 are shown. Light distribution 880 may be a light distribution characteristic for headlight 570. The view in FIG. 8A is similar to the views from FIG. 1A, 2A, 3A, or 4A, with the exception that in FIG. 8A, a light cone produced by headlight 570, which is not explicitly provided with a reference numeral, is divided by lines into multiple sectors, and light distribution 880 associated with the light cone is shown. Light distribution 880 represents a profile of a reflected light quantity along a light range in the light cone of headlight 570. On a vehicle-proximal end of the light range or the light cone, light distribution 880 displays a greater light quantity than on a vehicle-remote end of the light range or the light cone. Light distribution 880 has a light quantity which decreases continuously from the vehicle-proximal end of the light range or the light cone to the vehicle-remote end of the light range or the light cone. According to this exemplary embodiment, a light distribution characteristic for the headlight 570 is reflected from the roadway.

If the area illuminated by headlight 570 is captured, for example, by camera 510 shown in FIG. 5, the characteristic light distribution is thus imaged on an image produced by the camera. The sectors shown in FIG. 8A may each be associated with one image area of the image, which is in turn associated with a specific light intensity value corresponding to the characteristic light distribution. An item of information about an arrangement of image areas corresponding to the characteristic light distribution and associated light intensity values may be stored as a reference. If an image captured by the camera of the instantaneous light distribution shown in FIG. 8A is compared to the information about the characteristic light distribution, no deviation or a deviation lying within a tolerance range between the instantaneous light distribution and the characteristic light distribution is ascertained. This indicates that the area of the roadway illuminated by headlight 570 is level.

FIG. 8B shows a view of a light distribution of a vehicle upon the presence of a roadway irregularity. A vehicle 500, a headlight 570, a light distribution 882, a deviation section 884, a bright area 886, and a dark area 888 are shown. The view in FIG. 8B is otherwise similar to the view from FIG. 8A, with the exception that in FIG. 8B a roadway irregularity, for example, in the form of a bump, is present in the roadway. The light cone produced by headlight 570 illuminates the roadway irregularity. Light distribution 882 results therefrom, which is changed in relation to the light distribution in FIG. 8A as a result of the roadway irregularity. Light distribution 882 is an instantaneous light distribution produced by headlight 570. Light distribution 882 deviates in deviation section 884 from the light distribution from FIG. 8A. Deviation section 884 is associated with the roadway irregularity. A light quantity deviating from a light distribution characteristic for headlight 570 is therefore reflected from the area of the roadway irregularity. For example, a bump is shown as the roadway irregularity in FIG. 8B. Bright area 886 corresponds to a flank of the bump facing toward vehicle 500. As a result of the inclination of the roadway in the area of the flank of the bump facing toward vehicle 500, the reflected light quantity in light distribution 882 is increased in bright area 886 in relation to adjoining areas in light distribution 882. Dark area 888 corresponds to a flank of the bump facing away from vehicle 500. As a result of the inclination of the roadway in the area of the flank of the bump facing away from vehicle 500, in dark area 888, the reflected light quantity in light distribution 882 is reduced in relation to adjoining areas in light distribution 882.

If an image captured by a camera of the instantaneous light distribution shown in FIG. 8B is compared to the information about the characteristic light distribution, no deviation or a deviation lying outside a tolerance range is ascertained between the instantaneous light distribution and the characteristic light distribution. This indicates that the area of the roadway illuminated by headlight 570 is uneven.

With reference to FIGS. 5 through 8B, a detection of a bump by “structure from shading” according to one exemplary embodiment of the present invention is explained hereafter. The detection may be made possible in this case by a system having control device 520 and optionally having vehicle camera 510 and headlights 570, the system detecting bumps with the aid of vehicle camera 510 and anticipatorily adapting the light distribution, for example, lowering it, to avoid dazzling oncoming vehicles 400 as a result of flashing of headlights 570, for example. The system knows the light distribution, for example, of low-beams, of headlight 570, i.e., it knows how much light is emitted in which direction. Under the assumption that the degree of reflection or the color is equal everywhere, it may be calculated how much light must arrive from which point in vehicle camera 510. If the light quantity deviates from the expected light quantity, there is possibly a bump, to which the system may react by an adaptation of the light emission of headlights 570. A differentiation may also be made between bump crests and bump troughs by analyzing various areas of the bump. For example, if a sequence of bright area 886 and dark area 888 is as shown in FIG. 8B, a bump crest is present. Correspondingly, the light emission of headlight 570 may either be raised or lowered before the bump depending on the present setting.

The system could be expanded by the recognition of the road topology, to also take into consideration a rise of the road. Such an item of information may also come from a navigation device, for example. The system is not restricted to the adaptation of a height of the light cone of the low-beams, for example, but rather the control information, for example, bump information, may also be relayed to other light functions. Algorithms, which operate based on a vertical object position, for example, AHC (adaptive high-beam control; sliding light range), OIC (object illumination control; marking light), and CHC (continuous high-beam control; dazzle-free high-beams) may thus adapt parameters. AHC and CHC could omit an increase of the light range or range until after the bump, optionally with a change of the de-bouncing strategy or waiting time or de-bouncing distance. OIC may already assume the correct, adapted position directly before the bump. The original parameters could be reset after passing the bump. The bump detection may predominantly be used in ALC (adaptive low-beam control) to adapt the low-beam light or the entire headlight module. A use in conjunction with OIC is also conceivable, in which objects are to be illuminated accurately. Furthermore, the bump detection may be used in conjunction with AHC and CHC, to adapt the illumination strategy, for example, to wait for an increase of the emission angle and/or the range until after the bump.

FIG. 9 shows a view of a two-dimensional image having a three-dimensional effect. The view in FIG. 9 is used to explain how a shading from a two-dimensional image may be interpreted as a volume shape. A spatial effect results due to the shading, for example, in the mind of an observer. This principle is also called “structure from shading,” the appearance of the volume of an object being inferred on the basis of the shading thereof. The view in FIG. 9 therefore illustrates a procedure with respect to FIGS. 8A and 8B based on the method from FIG. 6 or the control device from FIG. 5.

Exemplary embodiments of the present invention therefore allow a anticipatory dynamic light range control with utilization of bump detection and optionally additionally a parameterization of AHC, CHC, OIC, etc. The utilization of “structure from shading” for detecting bumps is significant, to accordingly adapt headlights anticipatorily. In other words, an analysis of the shading pattern is carried out for bump recognition and optionally a precautionary adaptation of the light angle is carried out.

The exemplary embodiments described and shown in the figures are only selected as examples. Different exemplary embodiments may be combined with one another completely or with respect to individual features. One exemplary embodiment may also be supplemented by features of another exemplary embodiment. Furthermore, method steps according to the present invention may be executed repeatedly and also in a sequence different than that described.

1.-10. (canceled)

11. A method for determining a roadway irregularity in a roadway section illuminated by at least one headlight of a vehicle, the method comprising:
recognizing an instantaneous light distribution of the at least one headlight of the vehicle which is produced in the roadway section; and
determining the roadway irregularity based on the instantaneous light distribution and a light distribution characteristic for the at least one headlight.

12. The method as recited in claim 11, wherein:
in the step of determining, a step of combining the recognized, instantaneous light distribution and the light distribution characteristic is carried out, to produce a combined light distribution, and
the roadway irregularity is determined based on the combined light distribution.

13. The method as recited in claim 12, further comprising checking whether the combined light distribution meets a roadway irregularity condition, wherein, in the step of determining the roadway irregularity, the roadway irregularity is determined if the combined light distribution meets the roadway irregularity condition.

14. The method as recited in claim 13, wherein the roadway irregularity condition has at least one light distribution pattern that represents at least one of a presence and a property of the roadway irregularity.

15. A method for controlling a light emission of at least one headlight of a vehicle, the method comprising:
determining a roadway irregularity according to a method for determining the roadway irregularity in a roadway section illuminated by the at least one headlight of a vehicle, the method for determining the roadway irregularity including:
recognizing an instantaneous light distribution of the at least one headlight of the vehicle which is produced in the roadway section, and
determining the roadway irregularity based on the instantaneous light distribution and a light distribution characteristic for the at least one headlight; and
ascertaining an item of control information for controlling the light emission of the at least one headlight of the vehicle based on the roadway irregularity.

16. The method as recited in claim 15, wherein the step of ascertaining is executed before the vehicle reaches the determined roadway irregularity.

17. The method as recited in claim 15, further comprising generating a pitching movement value for the at least one headlight based on the determined roadway irregularity, wherein, in the step of ascertaining, the control information is formed, to control the light emission of the at least one headlight while using the generated pitching movement value.

18. The method as recited in claim 15, wherein, in the step of ascertaining, the control information is additionally ascertained based on at least one of surrounding data and travel data of the vehicle.

19. A device for determining a roadway irregularity in a roadway section illuminated by at least one headlight of a vehicle, the method comprising:
an arrangement for recognizing an instantaneous light distribution of the at least one headlight of the vehicle which is produced in the roadway section; and
an arrangement for determining the roadway irregularity based on the instantaneous light distribution and a light distribution characteristic for the at least one headlight.

20. A device for controlling a light emission of at least one headlight of a vehicle, the method comprising:
an arrangement for determining a roadway irregularity according to a device for determining the roadway irregularity in a roadway section illuminated by the at least one headlight of a vehicle, the device for determining the roadway irregularity including:
an arrangement for recognizing an instantaneous light distribution of the at least one headlight of the vehicle which is produced in the roadway section, and
an arrangement for determining the roadway irregularity based on the instantaneous light distribution and a light distribution characteristic for the at least one headlight; and
an arrangement for ascertaining an item of control information for controlling the light emission of the at least one headlight of the vehicle based on the roadway irregularity.

21. A computer program product having program code for carrying out a method for determining a roadway irregularity in a roadway section illuminated by at least one headlight of a vehicle, the method comprising:
recognizing an instantaneous light distribution of the at least one headlight of the vehicle which is produced in the roadway section; and
determining the roadway irregularity based on the instantaneous light distribution and a light distribution characteristic for the at least one headlight

22. A computer program product having program code for carrying out a method for controlling a light emission of at least one headlight of a vehicle, the method comprising:
determining a roadway irregularity according to a method for determining the roadway irregularity in a roadway section illuminated by the at least one headlight of a vehicle, the method for determining the roadway irregularity including:
recognizing an instantaneous light distribution of the at least one headlight of the vehicle which is produced in the roadway section, and
determining the roadway irregularity based on the instantaneous light distribution and a light distribution characteristic for the at least one headlight; and
ascertaining an item of control information for controlling the light emission of the at least one headlight of the vehicle based on the roadway irregularity.
